(19) United States
(12) Patent Application Publication
(10) Pub. No.: US 2026/0338548 A1
(43) Pub. Date: Oct. 29, 2026

(54) METHOD AND DEVICE FOR MONITORING THE INTERIOR OF A VEHICLE AND VEHICLE

(71) Applicant: AUDI AG, Ingolstadt (DE)

(72) Inventors: Dennis BÖHMLÄNDER, Ingolstadt (DE); Raul GARCIA GOMEZ, Beilngries (DE); Markus KÖBE, Hepberg (DE)

(73) Assignee: AUDI AG, Ingolstadt (DE)

(21) Appl. No.: 19/552,253

(22) Filed: Feb. 27, 2026

(30) Foreign Application Priority Data
Apr. 24, 2025 (DE) 102025115839.8

(51) Int. Cl. G01B 21/28

(52) U.S. Cl. CPC G01B 21/28

(57) ABSTRACT

A method for monitoring the interior of a vehicle including the steps of: detecting interior data of a vehicle interior by at least one detection device; determining a volume of the vehicle interior based on the detected interior data; determining a volume change based on the determined volume of the vehicle interior; and detecting at least one deformation of the vehicle and/or at least one intrusion into the vehicle interior based on the determined volume change, as well as a corresponding device for monitoring the interior of a vehicle and a vehicle with such a device.

### FIELD

The invention relates to a method and device for monitoring the interior of a vehicle. Furthermore, the invention relates to a vehicle with such a device.

### BACKGROUND

There are vehicles known to use various sensors to monitor the interior in order to increase the safety of the occupants. These monitoring systems can detect fatigue, distraction, and other conditions in individuals. Furthermore, collision detection systems are known that can detect a collision indirectly via changes in acceleration and pressure. In addition to accelerations and forces acting on a vehicle occupant during a collision between a vehicle and a foreign object, deformations of the vehicle or intrusions, for example of vehicle parts, into the passenger compartment can also cause undesirable conditions for the vehicle occupant. Since known collision detection systems only detect collisions indirectly via changes in acceleration and pressure, they have significant limitations regarding the accuracy of the accident severity and therefore cannot provide a reliable method to enable improved initiation of rescue measures and a precise estimation of the accident severity.

For example, DE 10 2013 221 282 A1 relates to a device and a method for determining an region-specific intrusion parameter of an intrusion in a sub-region of a vehicle, wherein a vehicle parameter and a parameter of a foreign object in a vehicle environment are detected. Depending on these parameters, a collision parameter for a future collision is determined. The region-specific intrusion parameter is then determined depending on a pre-known relationship between the collision parameter and the region-specific intrusion parameter. Predicting an region-specific intrusion parameter based on a known relationship and a collision parameter predicted using vehicle and foreign object parameters allows safety measures to be initiated more quickly. However, this does not allow for precise detection of the intrusion after an accident and thus does not enable the determination of the actual severity of the accident in order to initiate improved rescue measures.

### SUMMARY

The invention is therefore based on the objective of improving a method for monitoring the interior of a vehicle. The invention also has the objective of improving a device for monitoring the interior of a vehicle. In particular, one of the aims of the invention is to precisely detect deformations and intrusions after an accident.

The problem is solved by a method, a device according and a vehicle. Advantageous embodiments and/or further developments are the subject of the dependent claims, the description and/or the attached figures. In particular, the independent claims of one claim category may also be further developed and/or combined analogously to the dependent claims of another claim category. Likewise, the device and method features described below can be combined and/or further developed.

Both the features specified in the patent claims and the features specified in the following embodiments of the device according to the invention are each suitable, either individually or in combination with one another, to further develop the subject matter according to the invention. The respective combinations of features do not represent any restrictions with regard to the further development of the subject matter of the invention, but are essentially only exemplary in nature.

According to a first aspect, a method for monitoring the interior of a vehicle is proposed. The vehicle can be a motor vehicle, for example a passenger car or truck. The motor vehicle can be an ego vehicle. The interior can be the vehicle interior. The interior can be defined and/or designed in particular by the passenger compartment of the vehicle. The vehicle interior can be specifically designed and/or intended for vehicle occupants.

The method includes the step: detecting interior data of the vehicle interior using at least one detection device. At least one detection device can be located in the interior of the vehicle, facing into the vehicle interior. Furthermore, at least one detection device may be configured for the continuous detection of interior data. The interior data can therefore be continuously detected. In a preferred embodiment, at least one detection device is designed as a camera, for example for detecting image data and/or video data. The interior data can therefore be interior image data and/or interior video data. Furthermore, at least one detection device can be part of a detection system, such as a camera system. At least one detection device and/or detection system can be designed as interior sensors. Existing sensors in the vehicle can also be used to detect interior data.

The method also includes the step of determining the volume of the vehicle interior based on the detected interior data. Determining the volume can involve finding a volume value. The volume can be determined at a defined point in time. The defined point in time can be a predetermined point in time. Additionally or alternatively, the volume can be determined cyclically, for example repeatedly after a certain period of time. The defined time can therefore occur after a predetermined period of time. Furthermore, the defined time and/or the specific duration for the vehicle can be predetermined, for example stored in a processing device. In a preferred variant, the volume of the vehicle interior can be determined at regular intervals based on the detected interior data. For example, the interior data can first be detected and then, essentially immediately afterwards, the volume of the vehicle interior can be determined based on the detected interior data. In one variant, the time of detecting the interior data can be assigned to the volume determined based on this interior data.

Additionally or alternatively, the defined time can be based as a reaction to a trigger. A trigger can be a captured parameter. A trigger can be exceeding and/or falling below a limit value. A trigger can be a signal and/or a specific event. The event could be, for example, a detected collision.

The process allows, in particular by means of sensors, a collision between the vehicle and a foreign object to be detected. A collision can be caused by or result from external influences on the vehicle interior. A foreign object can be another vehicle, a person, or another living being. Alternatively, a foreign object can be an infrastructure or part of an infrastructure. Infrastructure can be, for example, a building, a part of a building, a traffic sign, or an obstacle. An obstacle could be, for example, a barrier, a guardrail, or a gate. Additionally or alternatively, collision information and/or a collision parameter can be received, for example from a collision detection system present in the vehicle. This allows the detected interior data and/or the determined volumes of the vehicle interior to be classified according to whether they were detected or determined before or after a collision.

In another variant, the detected interior data and/or the specific volume(s) can be stored. The determined volume value(s) can be stored. Storing can take place in the processing device. For this purpose, the processing device may include a storage medium.

The determined volume or volume value can be analyzed. The analysis can be performed using an algorithm. The analysis may include a plausibility check. For example, the volume or volume value can be analyzed to determine whether a meaningful volume or volume value is present. The volume or volume value may be permissible within a range that lies within a defined value range, for example for a subsequent comparison. The volume or volume value may be impermissible within a range that lies without the defined value range. In this way, a misinterpretation of the determined volume or the determined volume value can be detected as early as possible. The defined value range can be stored in the processing device.

A further step in the method involves determining a change in volume based on the specified volume of the vehicle interior. This may entail the comparison of specific volumes in succession over time. Comparison can take place in the processing device. This allows changes in the volume of the vehicle interior to be detected. Determining and/or comparing volume changes can be done cyclically, especially at regular intervals.

In one variant, a basic volume or basic volume value for the vehicle interior can be specified or determined, for example, based on the detected interior data. The basic volume or volume value can be stored or become stored in the processing device. A volume or volume value determined based on the detected interior data can then be compared with the basic volume value. The comparison can be carried out using the processing device, whereby changes in the volume of the vehicle interior can be detected. The comparison with the basic volume value also can be done cyclically, especially at regular intervals.

In every comparison, for example as part of a plausibility check, it can be compared whether the subsequently determined volume or volume value is smaller than the previously determined volume or volume value. Alternatively, it can be compared whether the determined volume or volume value is smaller than the basic volume or basic volume value. Thus, the change in volume can be determined based on the result of the comparison. In one variant, the change in volume can be determined by the difference in volumes or volume values, for example by the difference between the two volume values determined, especially consecutively, or by the difference between the determined volume value and the basic volume value. The difference can be considered a measure of the change in volume of the vehicle interior. The volume change can be stored in the processing device. In another variant, the determined volume change and/or the determined difference can be evaluated, for example using the processing device. Further parameters, especially vehicle parameters, can be taken into account during the evaluation. Vehicle parameters can include, for example, vehicle speed, vehicle acceleration, trajectory, vehicle weight, vehicle type, structural stiffness of vehicle structures, vehicle occupancy and/or other dynamic or static vehicle states.

This is preferred for detecting whether or not a change in the volume of the vehicle interior has occurred. The determined volume changes can be continuously stored, for example in the processing device. Furthermore, it can be determined whether the volume of the vehicle interior has become smaller or larger. If a change in the volume of the vehicle interior has occurred, an effect on the vehicle interior and/or on the vehicle can be identified based on the determined volume change.

The effect could be a defect and/or damage to the vehicle. The effect may be a consequence of a collision. For example, the effect could be inside the vehicle interior. The effect can be a deformation and/or intrusion. The deformation could be a deformation of the vehicle interior. For example, the deformation could be a deformation of the vehicle and/or the interior fittings within the vehicle interior. The deformation can result in changes, especially changes in volume, to the vehicle interior. Intrusion can be understood as the penetration of vehicle parts or foreign objects into the vehicle interior. An intrusion can be an object that protrudes at least partially into the vehicle interior or is located entirely inside the vehicle interior. An intrusion can enter or have entered the vehicle interior, at least partially, from outside, for example as a result of a collision.

A further step of the method involves detecting at least one deformation of the vehicle and/or at least one intrusion into the vehicle interior based on the determined volume change. Furthermore, the position, shape, or structure of at least one deformation and/or at least one intrusion can be determined based on the detected interior data. Detection can take place by the processing device. For this purpose, the processing device may include an algorithm. The algorithm can be designed to analyze the detected interior data, determine volume changes, and, based on this, detect deformations and/or intrusions. The detected deformation and/or intrusion can be continuously stored. Storing can take place in the processing device.

In a preferred variant, the vehicle interior can be divided into multiple interior segments. The vehicle interior can therefore be or become segmented into a plurality of defined interior segments. Preferably, the vehicle interior is or will be virtually divided into multiple interior segments. Segmentation can therefore be or comprise virtual segmentation. In a variant, the detected interior data of the vehicle interior can be divided into multiple interior segments. This can include interior data for essentially the entire vehicle interior. Virtual segmentation allows a single detection device to be used for the plurality of defined interior segments. The interior segments can represent parts of the vehicle interior and, for example, spatially define it. Furthermore, interior segments can be spatially connected and/or spatially separated. Furthermore, each interior segment can represent a defined volume and/or have a defined basic volume value.

In one variant, interior data can be detected for each interior segment, for example simultaneously or sequentially, in particular by means of at least one detection device. The detection of interior data can be performed for all interior segments using a single detection device. Alternatively, the interior data of the interior segments can be detected using multiple detection devices.

For each interior segment, the volume or volume value can be determined based on the respective interior data, in particular those assigned to the respective interior segment. The detected interior data can be assigned to a respective interior segment beforehand. Finally, the change in volume can be determined for each interior segment. Furthermore, at least a deformation of the vehicle and/or at least an intrusion into the respective interior segment can be detected based on the volume change associated with the respective interior segment.

The volumes of the interior segments can be determined at a defined point in time. Each volume value of the specified volumes can be stored individually for each defined interior segment. The volume values can be stored in the processing device. Each individual volume value can be compared with a basic volume value that is assigned to the respective defined interior segment from the plurality of defined interior segments. From each compared pair of volume value and basic value of the associated defined interior segment, a difference can be formed, resulting in a plurality of differences. Alternatively, the volume values determined subsequently for each interior segment can be compared. From each compared pair of volume values of the corresponding interior segment a difference can be formed, also resulting in a plurality of differences.

The differences can be evaluated individually or together. Evaluating the plurality of differences makes it possible not only to determine a change in volume in the respective defined interior segment. It is also possible to determine location information and/or direction information. The location information and/or the direction information can be used to determine where a volume change occurs within the vehicle interior and/or in which direction and/or from which direction the volume change is propagated. The location information and/or the direction information can be stored in the processing device.

According to another embodiment, determining the volume of the vehicle interior can include determining the respective volume of a plurality of defined interior segments within the vehicle interior. The volumes of the plurality of defined interior segments can be added together and provided and/or stored as a total volume value, for example in the processing device.

The total volume value can be compared with a basic volume value, where the basic volume value has been specified and/or determined for the entirety of the plurality of defined interior segments. The basic volume value for the entirety of the defined interior segments can be predefined for the vehicle, for example, stored in the processing device.

In another variant, the method can comprise determining and/or providing at least one accident parameter and/or a degree of accident severity. Determining at least one accident parameter and/or the degree of accident severity can be based on the determined volume change and/or on the at least one detected deformation and/or intrusion. At least one accident parameter and/or the degree of accident severity can be a measure of how high the damage to the vehicle interior is, how large/severe the intrusion is and/or how large/severe the deformation is.

In another variant, the method can include generating and/or providing information for output to a transmission device. Determining and/or providing the information can be based on the determined volume change and/or on the at least one detected deformation and/or intrusion. The transmission device can be a transmission device of the vehicle. Furthermore, the transmission device may be or include a communication interface. Providing the information may include sending and/or transmitting the information, for example via the communication interface. It may also be possible to transmit the information to a recipient or receiving device. For example, Car2X and/or Car2Car communication may be provided. The information can comprise an emergency call signal, at least one accident parameter and/or the degree of accident severity. Additionally or alternatively, image and/or video data can also be transmitted as information. The image and/or video data may be based on or be the captured interior data. The information received and/or transmitted via the communication interface can be made available via the processing device.

The at least one accident parameter and/or the degree of accident severity can be determined based on the detected interior data, the determined volume change(s), the detected deformation(s) of the vehicle and/or the detected intrusion(s) into the vehicle interior. Furthermore, an assessment of the severity of the accident can be carried out. The degree of accident severity can represent the estimate.

An emergency call signal can be a so-called "eCall". The emergency call signal can be initiated after the detection of an accident, especially a serious one. The communication interface can trigger an emergency call from the vehicle to an external emergency call center. An emergency call center can be the police, the emergency doctor, the fire department, or a similar rescue service. The triggering can in particular occur automatically and/or without user intervention.

After the emergency call is triggered, the information can be transmitted to the emergency call center. In this way, targeted preparations and measures can be initiated by the emergency call center even before emergency services arrive at the scene of the accident, so that rescue workers can react quickly and effectively.

The entire method can be repeated completely or in sections. The repetition can occur multiple times or continuously. However, it is also possible that the method is only carried out, for example, if a collision has been detected and/or predicted. In this case, the interior data can be detected immediately before the predicted collision time and/or immediately after the collision.

In another variant, the method can include reconstructing an accident. The reconstruction can take place based on the volume change(s), the detected deformation(s) of the vehicle and/or the detected intrusion(s) into the vehicle interior. Alternatively, the aforementioned data and information can be provided for accident reconstruction. Furthermore, the detected interior data, the determined volume change(s), the detected deformation(s) of the vehicle and/or the detected intrusion(s) into the vehicle interior can be used and/or provided as data for development and/or accident research. The data can provide insights into the collision behavior of the vehicle and/or the field situation.

According to a further aspect, a device for monitoring the interior of a vehicle is proposed. The device can be configured to perform the method described above and/or below. The device is specifically designed to monitor the vehicle interior, for example before and after a collision or accident. Preferably, the device is configured to monitor and/or detect changes in the vehicle interior.

The device includes at least one detection device. The at least one detection device is designed to detect interior data from the vehicle interior. Preferably the at least one detection device can be located in the interior of the vehicle, facing into the vehicle interior. For example, at least one detection device can be arranged or arranged behind the windshield of the vehicle. Furthermore, the at least one detection device may be configured for the continuous detecting of interior data. In a preferred embodiment, the at least one detection device is designed as a camera, in particular for detecting image data and/or video data. Furthermore, the at least one detection device can be part of a detection system, such as a camera system. The at least one detection device and/or detection system can be designed as interior sensors.

The device also comprises a processing device. The processing device is designed to determine the volume of the vehicle interior based on the detected interior data. For this purpose, the processing device can receive the interior data from at least one detecting device. Furthermore, the processing device is designed to determine a change in volume based on the determined volume of the vehicle interior and to detect at least a deformation of the vehicle and/or at least an intrusion into the vehicle interior based on the determined change in volume. The processing device may comprise an evaluation unit for this purpose. The evaluation unit can be configured to process and/or evaluate the interior data provided by at least one detection device. In one variant, the processing device can be a control device or part thereof. For example, the processing device can be an Electronic Control Unit (ECU) or part thereof.

The processing device and/or its evaluation unit may include at least an electronic control system, at least a microcomputer and/or at least a processor. The processing device can be connected to the at least one detection device, in particular in such a way that the processing device can receive signals and/or data from the at least one detection device. Furthermore, the processing device may include at least one storage device, such as a data storage device. In one variant, the processing device can also include a computer program product. The computer program product can be stored in at least one memory. For example, the at least one storage device can be set up as a storage medium for storing data sets, algorithms, program code and/or programs.

In another variant, the processing device can include a transmission device. The transmission device can be configured to send and/or transmit information and/or data. In one embodiment, the transmission device can be configured as a communication interface. The communication interface can be designed for communication, for example wirelessly, in particular for sending and/or receiving data, with an external receiver or receiving device. In one variant, the communication interface can implement Car2X and/or Car2Car communication.

According to a further aspect of the invention, a vehicle is provided. The vehicle can be a motor vehicle, for example a passenger car or truck. The motor vehicle can be an ego vehicle. The vehicle may have the vehicle interior. The interior can be defined and/or designed in particular by the passenger compartment of the vehicle. The vehicle interior can be specifically designed and/or intended for vehicle occupants. The vehicle can be designed or provided for performing the method described above and/or below. In a preferred variant, the vehicle may comprise the device described above and/or below for monitoring the interior of the vehicle.

In summary, and in other words, the invention provides, among other things, a method and/or a device for monitoring the interior of a vehicle, in particular for monitoring before and after an accident. Deformation and/or intrusion detection in the post-crash situation can be implemented, for example, through interior sensors. A detection device, such as a camera or camera system, may be installed in a vehicle to monitor the interior before and after an accident. A change in volume can be detected through virtual segmentation of the interior and cyclical evaluation of these segments. Each segment can represent a specific volume. The segments can be evaluated at regular intervals to detect changes in volume. Furthermore, an algorithm can analyze the data and detect volume changes that indicate a deformation or intrusion. Based on the volume change, deformations of the vehicle and/or possible intrusions can be identified. Furthermore, an assessment of the severity of the accident can be carried out. In one variant, in the event of a detected deformation and/or intrusion, a so-called eCall can be triggered, which can inform rescue services.

The invention allows for the precise detection of deformations and/or intrusions following a collision. This information allows rescue workers to react quickly and effectively. Furthermore, a precise assessment of the severity of an accident can be made possible. This allows rescue measures to be initiated in a more targeted and improved manner. Furthermore, vehicle safety can be improved. Furthermore, more precise data about the accident sequence can be provided for accident research. Detailed information about the effects of collisions can also be provided.

### BRIEF DESCRIPTION OF THE FIGURES

Exemplary embodiments of the invention are described in more detail below with reference to the figures, in which, schematically and by way of example:

FIG. 1 shows a vehicle with a device for monitoring a vehicle interior; and

FIG. 2 shows a flowchart of a method for monitoring a vehicle interior.

### DETAILED DESCRIPTION

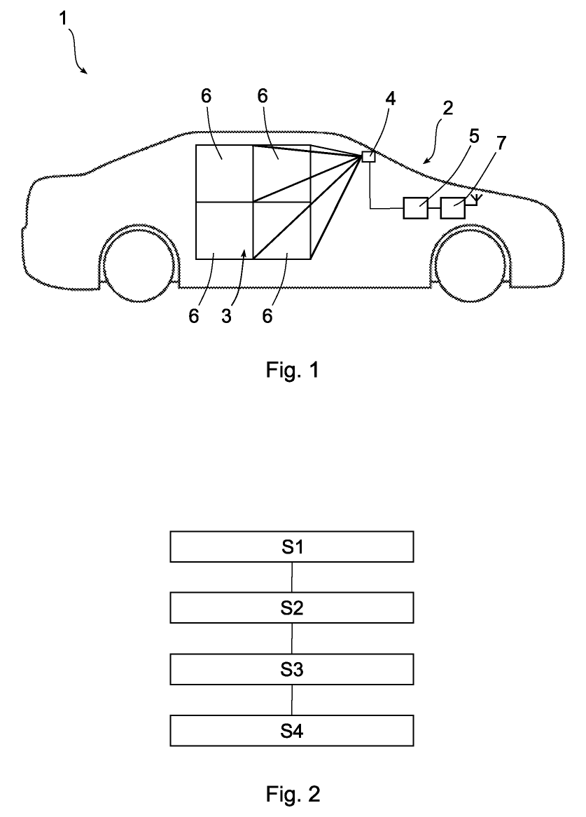

FIG. 1 shows a vehicle 1 with a device 2 for monitoring a vehicle interior 3. The vehicle interior 3 is, for example, the interior of a passenger compartment of the vehicle 1. The device 2 comprises a detection device 4 and a processing device 5. The detection device 4 and the processing device 5 are connected to each other for transmitting data. In the present embodiment, the detection device 4 is designed as a camera which is arranged on the windshield of the vehicle 21 with a viewing direction into the vehicle interior 3. The detection device 4 detects interior data of the vehicle interior 3 in the form of image and/or video data, which is transferred to the processing device 5 for evaluation.

The processing device 5 is designed to determine a volume of the vehicle interior 3 based on the detected interior data. This can involve a virtual segmentation of the vehicle interior 3 into multiple interior segments 6, each of which can represent a specific volume of vehicle interior 3. FIG. 1 shows four defined interior segments 6 as examples. Furthermore, the processing device 5 is designed to determine a volume change based on the determined volume of the vehicle interior 3, and to detect at least one deformation of the vehicle 1 and/or at least one intrusion into the vehicle interior 3 based on the determined volume change.

The device 1 further comprises a communication interface 7 which is coupled to the processing device 5. Data, information and parameters can be exchanged between the processing device 5 and the communication interface 7. The communication interface 7 can provide and forward information to internal and/or external recipients.

FIG. 2 now schematically shows a flowchart of a method for monitoring a vehicle interior 3 of vehicle 1.

In step S1 interior data of a vehicle interior 3 are detected by means of at least one detection device 4. The interior data is then transferred to the processing device 5. In a variant, the interior data can be continuously detected.

In step S2, a volume of the vehicle interior 3 is determined based on the detected interior data. In one variant, the volume can be determined cyclically. Furthermore, the vehicle interior 3 can optionally be virtually divided or segmented into multiple interior segments 6, wherein the volume for each interior segment 6 is then determined based on the respective interior data.

In step S3 a volume change is determined based on the determined volume of the vehicle interior 3. The specific volume changes can be stored. The determination of the volume change can, for example, be done cyclically. In the case of a virtual segmentation into interior segments 6, a volume change can be determined for each interior segment 6.

In step S4 at least one deformation of the vehicle 1 and/or at least one intrusion into the vehicle interior 3 are detected based on the determined volume change. The detected deformations and/or intrusions can be stored. In one variant, at least one accident parameter and/or a degree of accident severity can be determined and/or provided based on the detected deformation and/or intrusion. Additionally or alternatively, information can be generated and/or provided for output to communication interface 7 based on the detected deformation and/or intrusion.

The term "can" is used in particular to denote optional features of the invention. Accordingly, there are also further developments and/or exemplary embodiments of the invention that additionally or alternatively have the respective feature or features.

From the combinations of features disclosed herein, isolated features can also be selected as needed and, by dissolving any structural and/or functional relationship that may exist between the features, used in combination with other features to define the subject matter of the claim. The order and/or number of all steps in the method can be varied.

### REFERENCE NUMERALS

1 vehicle
2 device for monitoring a vehicle interior
3 vehicle interior
4 detection device
5 processing device
6 interior segments
7 communication interface
S1 step of detecting interior data of the vehicle interior
S2 step of determining a volume of the vehicle interior
S3 step of determining a volume change
S4 step of detecting at least one deformation and/or intrusion

1. A method for monitoring an interior of a vehicle, comprising:
detecting interior data of a vehicle interior by at least one detection device;
determining a volume of the vehicle interior based on the detected interior data;
determining a volume change based on the determined volume of the vehicle interior; and
detecting at least one deformation of the vehicle and/or at least one intrusion into the vehicle interior based on the determined volume change.

2. The method according to claim 1, wherein the interior data are continuously detected, and/or in that the determination of the volume and/or the determination of the volume change is carried out cyclically.

3. The method according to claim 1, wherein the vehicle interior is or becomes divided into multiple interior segments.

4. The method according to claim 3, wherein interior data is detected for each interior segment and the volume is determined for each interior segment based on the respective interior data, wherein a volume change is determined for each interior segment.

5. The method according to claim 3, wherein the vehicle interior and/or the detected interior data of the vehicle interior are virtually divided into multiple interior segments, wherein each interior segment represents a defined volume and/or a volume change is determined for each interior segment.

6. The method according to claim 1, wherein at least one accident parameter and/or a degree of accident severity is determined and/or provided based on the determined volume change and/or based on the at least one detected deformation and/or intrusion.

7. The method according to claim 1, wherein an information to be output to a transmission device is generated and/or provided based on the determined volume change and/or based on the at least one detected deformation and/or intrusion.

8. The method according to claim 1, further comprising: continuous storing of the determined volume changes and/or the detected deformation and/or intrusion.

9. A device for monitoring an interior of a vehicle, comprising:
at least one detection device for detecting interior data of a vehicle interior; and
a processing device, which is designed to determine a volume of the vehicle interior based on the detected interior data, to determine a volume change based on the determined volume of the vehicle interior, and to detect at least one deformation of the vehicle and/or at least one intrusion into the vehicle interior based on the determined volume change.

10. A vehicle comprising a device according to claim 9.

11. The method according to claim 2, wherein the vehicle interior is or becomes divided into multiple interior segments.

12. The method according to claim 11, wherein interior data is detected for each interior segment and the volume is determined for each interior segment based on the respective interior data, wherein a volume change is determined for each interior segment.

13. The method according to claim 11, wherein the vehicle interior and/or the detected interior data of the vehicle interior are virtually divided into multiple interior segments, wherein each interior segment represents a defined volume and/or a volume change is determined for each interior segment.

14. The method according to claim 2, wherein at least one accident parameter and/or a degree of accident severity is determined and/or provided based on the determined volume change and/or based on the at least one detected deformation and/or intrusion.

15. The method according to claim 3, wherein at least one accident parameter and/or a degree of accident severity is determined and/or provided based on the determined volume change and/or based on the at least one detected deformation and/or intrusion.

16. The method according to claim 4, wherein at least one accident parameter and/or a degree of accident severity is determined and/or provided based on the determined volume change and/or based on the at least one detected deformation and/or intrusion.

17. The method according to claim 5, wherein at least one accident parameter and/or a degree of accident severity is determined and/or provided based on the determined volume change and/or based on the at least one detected deformation and/or intrusion.

18. The method according to claim 2, wherein an information to be output to a transmission device is generated and/or provided based on the determined volume change and/or based on the at least one detected deformation and/or intrusion.

19. The method according to claim 3, wherein an information to be output to a transmission device is generated and/or provided based on the determined volume change and/or based on the at least one detected deformation and/or intrusion.

20. The method according to claim 4, wherein an information to be output to a transmission device is generated and/or provided based on the determined volume change and/or based on the at least one detected deformation and/or intrusion.
